(19) United States
(12) Patent Application Publication
(10) Pub. No.: US 2004/0120784 A1
(43) Pub. Date: Jun. 24, 2004

(54) Small vehicle wheel chock system

(75) Inventor: David D. Sargent, Rivera Beach, FL (US)

Correspondence Address: DONALD R. BAHR, 2608 MERIDA LN, TAMPA, FL, 33618, US

(73) Assignee: GREEN TOUCH INDUSTRIES, INC

(21) Appl. No.: 10/321,399

(22) Filed: Dec. 18, 2002

(51) Int. Cl. B60P 3/06

(52) U.S. Cl. 410/20

(57) ABSTRACT

Wheel chocks are commonly used in connection with large vehicles to secure these vehicles to a transporting vehicle. For example the transporting of automobiles on a railroad car. This invention relates to wheel chocks which are particularly suited for use with small vehicles i.e. all terrain vehicles, lawn mowers etc. The subject wheel chock has an adjustment means on both sides of the chock whereby the length of a tie down strap can be varied. The tie down strap of the composite wheel chock system may further incorporate an adjustment means intermediate of the ends of the tie down strap. The composite wheel chock system can accommodate a wide variety of wheel sizes and adjustments can be made from a variety of positions. The wheel chocks are used in pairs to form a wheel chock system. The wheel chocks are secured to a support surface of a transporting vehicle.

### FIELD OF THE INVENTION

This invention is concerned with wheel chocks that are particularly suited for use with small vehicles such as lawn mowers and all terrain vehicles. More particularly this invention is concerned with a wheel chock that can be easily adjusted to accommodate a wide variety of wheel sizes. The wheel chock system of this invention incorporates a plurality of adjustments to facilitate its use with various wheel sizes. In contrast to this adaptability most prior art wheel chocks have only limited adjustment capabilities. In order to permit this adaptability the wheel chocks system of this invention has at least two and preferably three adjustment points.

### BACKGROUND OF THE INVENTION

Small wheeled vehicles have become very popular in recent years. These vehicles are used for both work and recreation. For example all terrain vehicles (herein after ATV) are widely used for recreation and riding mowers and are extensively used for grass cutting. These small wheeled vehicles are often transported from place to place. For example ATV's are almost always transported to a suitable riding site, as the riding of ATV's is often severely restricted. Likewise riding power mowers are almost always transported from job to job on either a trailer or in the bed of a truck.

Regardless of the type of vehicle being transported there is a real need for a quick and easy way to secure the vehicle being transported to a trailer or to the bed of a truck. This securing can be effected in many ways for example the vehicle being transported can be tied to the transporting trailer or truck. Another method which is used to secure a small vehicle to a trailer or truck is by use of a plurality of wheel chocks. A wheel chock is essentially a device which prevents the wheels of the vehicle for being transported from rolling.

In most instances the same small vehicle is repeatedly transported in or on the same transporting vehicle i.e. the same riding power mover being transported on the same trailer from job to job. Since the small vehicle being transported and the vehicle doing the transporting are the same, a set of wheel chocks can be affixed to a support surface which is integral with the transporting vehicle.

The wheel size of the vehicle being transported can vary from vehicle to vehicle. In order to be effective the wheels of the vehicle being transported must be secured to the wheel chock. In accordance with this invention various sized wheels can be readily and easily secured to the wheel chock system of this invention.

### BRIEF DESCRIPTION OF THE DRAWINGS

FIG. 1 is a perspective view showing the wheel chock for this invention.

FIG. 2 is a perspective view showing a pair of wheel chocks with a wheel secured thereto.

FIG. 3 is a side view showing a pair of wheel chocks which are secured to a support surface.

FIG. 4 is a cut away side view showing a tensioning device with an adjustable strap means.

FIG. 5 is a cut away side view showing the wheel chock of this invention.

### OBJECTS OF THE INVENTION

The primary object of this invention is a wheel chock system whereby a small vehicle can be readily secured to a support surface of a transporting vehicle.

Another object of this invention is a wheel chock that can be readily secured to a transporting vehicle.

Still another object of this invention is a wheel chock system having an adjustment means on both sides of the chock system whereby a vehicle wheel can be secured in the chock system.

Still another object of this invention is a wheel chock system having an adjustment means on both sides of the chock system and an intermediate adjustment means.

Lastly an object of this invention is a wheel chock system whereby a vehicle can be easily secured to a transporting vehicle from almost any position.

### DESCRIPTION OF THE PREFERRED EMBODIMENT

As is briefly discussed above this invention is concerned with wheel chocks and a wheel chock adjustment system whereby a variety of wheel sizes can be readily accommodated by the wheel chock system.

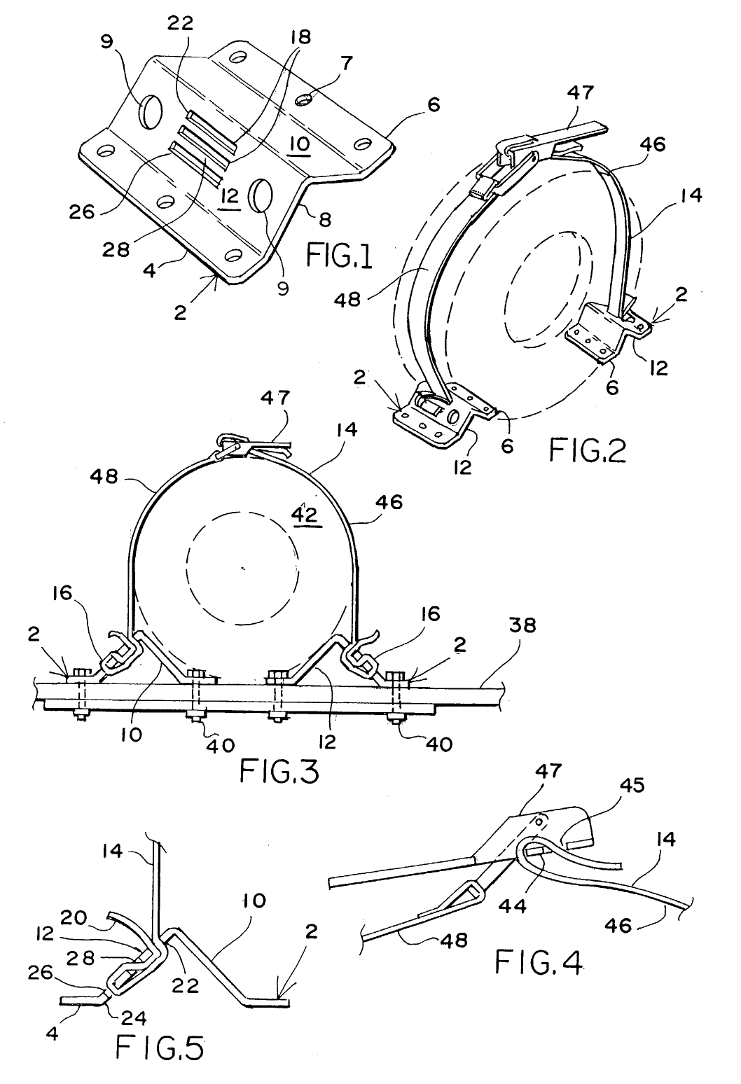

Referring to FIG. 1 it can be seen that the wheel chock 2 component of the subject invention has a pair of planar bases 4 and 6 which are disposed apart. Planar bases 4 and 6 are interconnected by a unitary assembly 8 which in turn has a pair of angularly disposed surfaces, inner surface 10 and outer surface 12. One of these angularly disposed surfaces 10 is biased against the wheel of the vehicle which is being transported. Wheel chock 2 is used in pairs, with a surface 10 of each chock being biased agents a wheel surface as is illustrated in FIGS. 2 and 3. The surface of the wheel chock which is defined as the inner surface, 10 in FIGS. 1 and 2, is biased against the wheel of the vehicle which is being transported. A tie down strap 14 is attached to each of the outer surfaces 12 via an adjustment means 16. Means are provided on each of these outer surfaces 12 for securing each end of tie down strap 14. Since two adjustment means are provided the length of tie down strap 14 can be varied at each of outer surfaces 12.

Surface 12 of wheel chock 2 further incorporates a pair of apertures 9 which are non functional and are incorporated therein by decorative purposes only.

It is understood by one skilled in the art that adjustment means 16 can assume many configurations.

The preferred adjustment means is illustrated in FIGS. 1 and 5 wherein it can be seen that the adjustment means comprises a plurality of slots 18 wherein tie down strap 14 is secured to wheel chock 2 by the threading of the tie down strap 14 through two or more of slots 18 as is best shown in FIG. 5. The preferred embodiment is illustrated in FIGS. 1-3 wherein outer surface 12 incorporates three slots 18. The securing of tie down strap 14 to wheel chock 2 is illustrated in FIG. 3 and 5 wherein it can be seen that the tie down strap 14 is secured to wheel chock 2 by the feeding of end 20 of tie down strap 14 through upper most slot 22 to the under side 24 of outer surface 12. End 20 is then passed through lower slot 26, through middle slot 28 and back out upper most slot 22.

As can be seen from FIGS. 2, 4 and 5 a composite wheel system comprises a pair of wheel chocks 2 which are secured to support surface 38 via fasteners 40. These fasteners are passed through apertures 7 which are integral with planer bases 4 and 6.

Inner surfaces 10 of wheel chocks 2 are position such that they will bias wheel 42, when wheel 42 engages inner planar base 6 of wheel chock 2.

As can be further seen from FIGS. 3 and 4 tie down strap 14 can be in two segments 46 and 48, and an additional adjustment point 44 can be provided intermediate of the ends of tie down strap 14 which are threaded through slots 45 which are integral with tensioning adjustment device 47.

When an over center adjustment device 47 is used tie down strap 14 is tensioned up on wheel 42 via adjustments which are made in slots 18 as are part of outer surfaces 12 of wheel chock 2.

If it is inconvenient for a user to make adjustments at either of the wheel chocks 2, an adjustment can be made via adjustment slots 45. It is understood by one skilled in the art that the tensioning up of tie down strap 14 is effected when over center adjustment device 47 is in an open position. Once the tensioning up of tie down strap 14 is effected over center adjustment device 47 is closed thereby causing tie down strap 14 to be further drawn into contact with wheel 42.

An important feature of this invention is that adjustments can be made to tie down strap 14 at a plurality of points. Therefore, if it is inconvenient for a user to make an adjustment at one point, because that point is not accessible, an adjustment to the length of the tie down strap 14 can be effected at, either of the two other adjustment points.

It is understood that wheel chocks 2 can be stamped out of cold rolled steel and tie down strap 14 can be formed from woven nylon webbing.

The above description and drawings are illustrative only since modifications can be made without departing from the present invention, the scope of which is to be limited only by the following claims.

What is claimed is:

1. A wheel chock comprising a structure having a pair of spaced apart planar bases which are adapted to being secured to a support surface of a transporting vehicle, said planar bases are joined together by a unitary assembly having at least two planar surfaces, wherein one of said planar surfaces is adapted to being biased against a wheel, of a vehicle which is being transported and the other of said planar surfaces incorporates a means for adjustably securing a tie down strap thereto.

2. The wheel chock of claim 1 wherein the planar bases incorporate a plurality of apertures whereby the wheel chock can be secured to a support surface of a transporting vehicle with fasteners.

3. The wheel chock of claim 1 wherein the means for adjustably securing a tie down strap comprises a plurality of elongated slots wherein the tie down strap is secured thereto by feeding the tie down strap through at least two of said elongated slots.

4. The wheel chock of claim 3 wherein the wheel chock incorporates three elongated slots.

5. The wheel chock of claim 1 wherein the spaced apart planar bases are interconnected, to each other, by a unitary assembly having at least two planar surfaces, the terminal ends of the unitary assembly being angularly secured to the planar bases.

6. The wheel chock of claim 2 wherein the spaced apart planar bases are interconnected, to each other, by a unitary assembly having at least two planar surfaces, the terminal ends of the unitary assembly being angularly secured to the planar bases.

7. The wheel chock of claim 3 wherein the spaced apart planar bases are interconnected, to each other, by a unitary assembly having at least two planar surfaces, the terminal ends of the unitary assembly being angularly secured to the planar bases.

8. The wheel chock of claim 4 wherein the spaced apart planar bases are interconnected, to each other, by a unitary assembly having at least two planar surfaces, the terminal ends of the unitary assembly being angularly secured to the planar bases.

9. The wheel chock assembly of claim 5 wherein the angularly disposition of the planar surfaces to the planar bases in about 45 degrees.

10. The wheel chock assembly of claim 6 wherein the angularly disposition of the planar surfaces to the planar bases in about 45 degrees.

11. The wheel chock assembly of claim 7 wherein the angularly disposition of the planar surfaces to the planar bases is about 45 degrees.

12. The wheel chock assembly of claim 8 wherein the angular disposition of the planar surfaces to the planar bases is about 45 degrees.

13. A composite wheel chock assembly for securing a wheel of a vehicle to a support surface on a transporting vehicle the comprising:
a. two wheel chocks, each wheel chock having a pair of spaced apart planar bases which are secured to the support surface of the transporting vehicle, wherein the planar bases are interconnected, to each other, by a unitary assembly having at least two planar surfaces, the terminal ends of the unitary assembly being angularly disposed to and integral with the planar bases, wherein one of said planar surfaces incorporates an adjustment means for securing a tic down strap,
b. said two wheel chocks being secured to a support surface of a transporting vehicle in a spaced apart relationship, wherein the planar surfaces of each of the wheel chocks which incorporate said adjustment means are outwardly disposed to each other,
c. a tie down strap the terminal ends of which are secured to the wheel chocks by the adjustment means.

14. The composite wheel chock system of claim 13 wherein the adjustment means for securing the tie down strap comprises at least two elongated slots, though which the tie down strap is woven.

15. The composite wheel chock system of claim 13 wherein the tie down strap comprises two segments, one terminal end of each segment being attached to a wheel chock and, the opposite terminal ends, of each segment of the tie down straps are adjustably interconnected to each other.

16. The composite wheel chock system of claim 15 wherein the means for adjustably inter connecting the opposite terminal ends of each segment of the tie down strap, comprises an over center tensioning device which incorporates a tie down strap adjustment means.

17. The composite wheel chock system of claim 16 wherein the tie down strap adjustment means comprises a plurality of slots which are integral with the over center tensioning device.

18. The composite wheel chock system of claim 17 wherein the over center tensioning device incorporates three slots.
